(19) United States
(12) Patent Application Publication
(10) Pub. No.: US 2023/0351534 A1
(43) Pub. Date: Nov. 2, 2023

(54) LEGAL EXAMINATION AND PRACTICE METHOD

(71) Applicant: Harley Ninham, Southwold (CA)

(72) Inventor: Harley Ninham, Southwold (CA)

(21) Appl. No.: 17/661,330

(22) Filed: Apr. 29, 2022

(51) Int. Cl. G06Q 50/18

(52) U.S. Cl. CPC G06Q 50/18

(57) ABSTRACT

A software application operable to facilitate a method wherein the method of the present invention facilitates legal examination and practice of law. The method of the present invention provides numerous legal activities such as but not limited to legal contract review. Legal contract review includes utilization of preferred parameters wherein the preferred parameters can establish moral or personal choices of the user and ensure compliance of the contract therewith. The present invention additionally provides an ability to facilitate pro-se practice of many areas of law. Tutorials and assistance with legal terminology are provided during utilization of the present invention. The present invention further provides automated validation of facts and facilitates direct communication with a legal practitioner. The method further employs utilization of case law and additionally includes a multitude of templates in order to facilitate pro-se filings.

### FIELD OF THE INVENTION

The present invention relates generally to legal practice, more specifically but not by way of limitation, a software application that facilitates a method of legal examination and practice wherein the present invention provides features such as but not limited to automated review of terms and conditions, interpretation of legal code, cross-reference of case law and legal procedural tutorials.

### BACKGROUND

As is known in the art, legal matters and procedures such as but not limited to contract law and litigation procedures are extremely complex. Whether it is reviewing and understanding a terms and conditions document associated with a purchase or engaging the court system for a procedural filing, these matters are cumbersome and typically require the utilization of a professional legal practitioner. For many individuals the cost of utilizing a legal practitioner is prohibitive and as such the individuals may be placing themselves at risk by not fully understanding a legal document which is associated with a purchase or through self-representation in other legal matters.

One example of risks many individuals encounter is the review of a terms and conditions documents or similar documents that are associated with a sale of a good or service. Almost all individuals are routinely presented with these types of documents and few actually take the time to review and less actually understand some of the potential inherent risks being assumed by the purchaser. Review of these documents not only takes a long time but also requires the understanding of many legal terms. Another complex matter in the legal arena is the preparation and filing of court documents and engagement in proceedings associated therewith. Regardless whether the matter is criminal or civil, the court system requires very specific document type filings and further requires adherence to civil procedure which is extremely complex. Just the preparation of the documents and understanding the format in which the document must be presented is beyond the capability and understanding of the average person.

Accordingly, there is a need for software application that can facilitate legal examination and practice of various legal matters wherein the software application of the present invention provides numerous automated activities in order to facilitate pro-se legal practice.

### SUMMARY OF THE INVENTION

It is the object of the present invention to provide a software application operable to execute legal examination of documents and further provide automated assistance of pro-se legal proceedings wherein the present invention is provided in its preferred embodiment in a software application loaded onto a smart phone.

Another object of the present invention is to provide a method of providing automated legal examination of documents and execution of legal procedures wherein the present invention includes layman translations of legal terms.

A further object of the present invention is to provide a software application operable to execute legal examination of documents and further provide automated assistance of pro-se legal proceedings wherein the present invention provides case law references in an automated manner relevant to the user’s legal needs.

Still another object of the present invention is to provide a method of providing automated legal examination of documents and execution of legal procedures wherein the present invention utilizes artificial intelligence to review documents for inconsistencies and provide alerts to the user.

An additional object of the present invention is to provide a software application operable to execute legal examination of documents and further provide automated assistance of pro-se legal proceedings wherein the present invention provides automated cross-reference of legal facts.

Yet a further object of the present invention is to provide a method of providing automated legal examination of documents and execution of legal procedures wherein the present invention is provided in all languages.

Another object of the present invention is to provide a software application operable to execute legal examination of documents and further provide automated assistance of pro-se legal proceedings wherein the present invention provides automated training for execution of legal proceedings.

Still another object of the present invention is to provide a method of providing automated legal examination of documents and execution of legal procedures wherein the present invention wherein the present invention provides access to all types of legal practitioners.

An additional object of the present invention is to provide a software application operable to execute legal examination of documents and further provide automated assistance of pro-se legal proceedings wherein the present invention facilitates notarization of documents.

Still a further object of the present invention is to provide a a method of providing automated legal examination of documents and execution of legal procedures wherein the present invention provides legal templates for a plurality of legal needs.

Yet another object of the present invention is to provide a software application operable to execute legal examination of documents and further provide automated assistance of pro-se legal proceedings wherein the present invention provides interface with electronic court systems so as to facilitate automated filing of legal documents and evidence.

A further object of the present invention is to provide a a method of providing automated legal examination of documents and execution of legal procedures wherein the present invention provides review of legal documents and automated fact checking of assertions and/or statements included therein.

Yet an additional object of the present invention is to provide a software application operable to execute legal examination of documents and further provide automated assistance of pro-se legal proceedings wherein the present invention provides the ability to electronically sign various document types.

Another object of the present invention is to provide a a method of providing automated legal examination of documents and execution of legal procedures wherein the present invention provides scanning and review of documents so as to reduce a professional fee associated therewith.

Yet a further object of the present invention is to provide a software application operable to execute legal examination of documents and further provide automated assistance of pro-se legal proceedings wherein the present invention employs artificial intelligence to execute data analytics to analyze and determine the majority decision made by legal practitioners for a similar scenario being evaluated.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagram of the infrastructure elements of the present invention; and

FIG. 2 is diagram of an exemplary workflow of the method of the present invention; and

FIG. 3 is an alternate exemplary workflow facilitated by the method of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a legal examination and practice method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

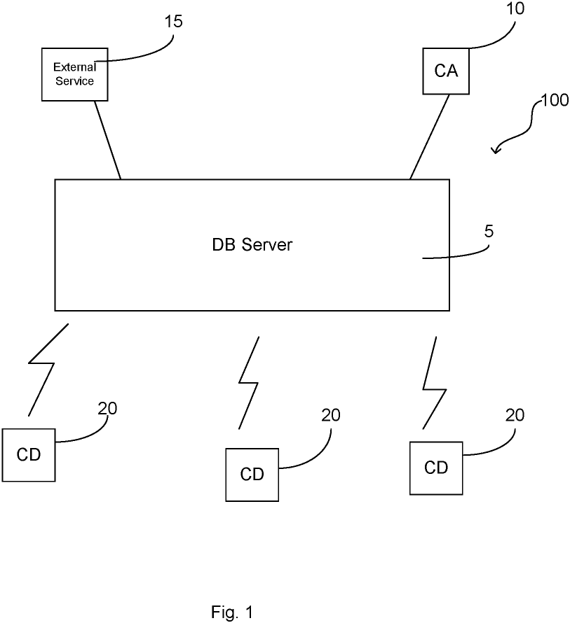

Referring in particular to the Figures submitted as a part hereof, FIG. 1 has illustrated therein a diagram of the infrastructure core elements utilized to execute the legal examination and practice method 100. A database server 5 is communicably coupled to the Internet utilizing suitable communication elements and protocols. The database server 5 is communicably coupled to at least one court access portal 10 so as to facilitate legal filings therewith as is further described herein. Additionally, at least one external informational source 15 is communicably coupled to the database server 5 and is operable to provide various types of information required to execute some of the steps of the method of the present invention. It should be understood within the scope of the present invention that the database server 5 could be communicably coupled to hundreds of alternate resources in order to facilitate the execution of the steps of the method of the present invention. By way of example but not limitation, the database server 5 could be communicably coupled to legal practitioners or a legal practitioner referral service. The users employ remote computing devices 20 having the software application of the legal examination and practice method 100 loaded thereon to execute the method of the present invention. It should be understood within the scope of the present invention that the computing devices 20 could be devices such as but not limited to smart phones.

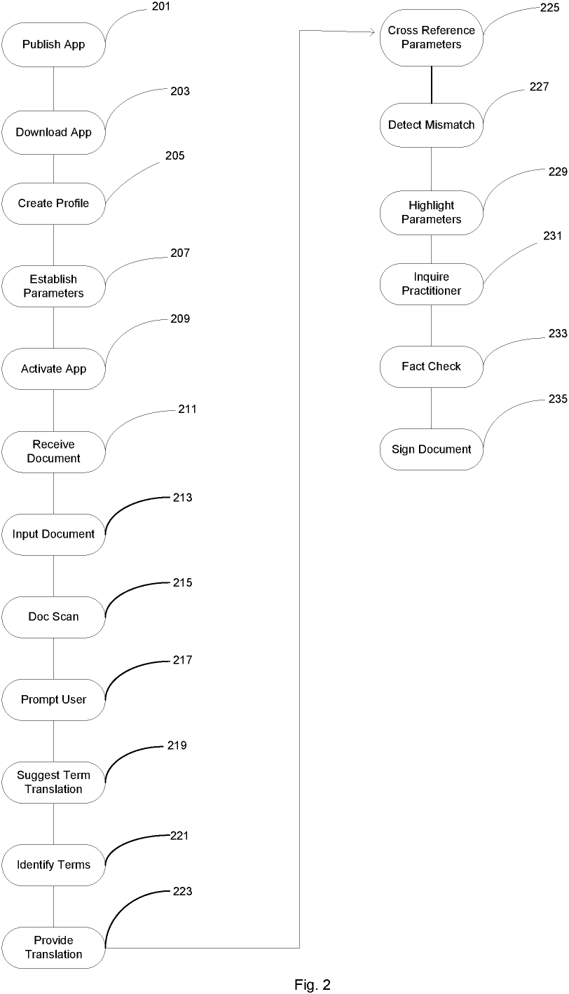

Now referring to FIG. 2 submitted herewith, an exemplary process of the legal examination and practice method 100 is diagrammed therein. It should be understood within the scope of the present invention that the process steps discussed and illustrated herein are exemplary and the method of the present invention could facilitate the steps in alternate orders and further include omission of some of the steps. In step 201, the operator of the legal examination and practice method 100 publishes the software application of the legal examination and practice method 100 to a location such as but not limited to a software application repository so as to make accessible to users. Step 203, a plurality of users download the software application to their computing device 20. In step 205, the user will create a profile within the software application to establish an account therewith. It should be understood within the scope of the present invention that the account profile of a user could include but not be limited to: age, name, gender, photograph, residence, email address and payment information.

In step 207, the user is prompted to establish preferred parameters with which are either moral or legal limits that they are unwilling to accept if the parameters are potentially violated in a terms and condition document, other document, or legal proceeding with which the user may become involved. These preferred parameters are stored as part of the profile of the user and will be cross referenced during any legal proceeding or document review that the present invention is executing for the user. By way of example but not limitation, if a user prefers to do business with an entity that establishes a certain percentage of their energy consumption comes from renewable sources then this is entered by the user into their profile and is cross referenced to ensure compliance therewith during execution of the legal examination and practice method 100. Another example but not a limitation is to input sources of goods from entities or countries that may engage in human rights violations. These preferred parameters can be routinely updated and the examples listed herein are solely examples and it should be understood within the scope of the present invention that the preferred parameters could include numerous alternate metrics.

In step 209, a user will activate the application subsequent determining a need for use thereof. Step 211, a user will receive a legal document such as but not limited to a terms and condition document related to a purchase of a good or service. In step 213, the user will input the document into the software application of the legal examination and practice method 100. It should be understood within the scope of the present invention that the document could be inputted employing various alternate techniques. In step 215, the software application of the present invention initiates a document scan of the inputted document. The document scan reviews all of the legal terms, conditions and other parameters of the inputted document. Ensuing the document scan, the software application will prompt the user in step 217. Step 219, the prompt of the user will be comprised of identification of terms and/or phrases that would most likely require translation into layman’s terms. These terms and phrases are provided to the user in a list format for the user to select all or a portion thereof to be translated by the software application of the present invention. In step 221, the user identifies the terms and/or phrases for which they would like to receive translation thereof.

Step 223, the software application of the legal examination and practice method 100 provides translation of the selected terms and/or phrases to the user. If required, it should be understood within the scope of the present invention that the software application could facilitate communication directly with a legal practitioner to further assist in the translation of the terms and/or phrases if desired by the user. Subsequent completion of the term translation, in step 225, the software application will cross reference the preferred parameters of the user against the document to ensure compliance therewith. In step 227, if a detected mismatch exists between the preferred parameters and language in the inputted document, this language is flagged by the software application. Step 229, the software application will provide a list of the clauses that are in contrast with the preferred parameters of the user. In step 231, if desired the user is prompted to contact a legal practitioner in order to obtain counsel on the conflict of the language of the inputted document and the preferred parameters. Step 233, the software application conducts a fact check of all statements and similar language included in the inputted document. The fact check is executed utilizing external sources 15 and any language identified within the inputted documentthat is factually incorrectis flagged by the software application. In step 235, ensuing all forementioned reviews and audits of the inputted document now meet the criteria of the user, the software application facilitates execution of the inputted document by the user via electronic signature or other similar techniques.

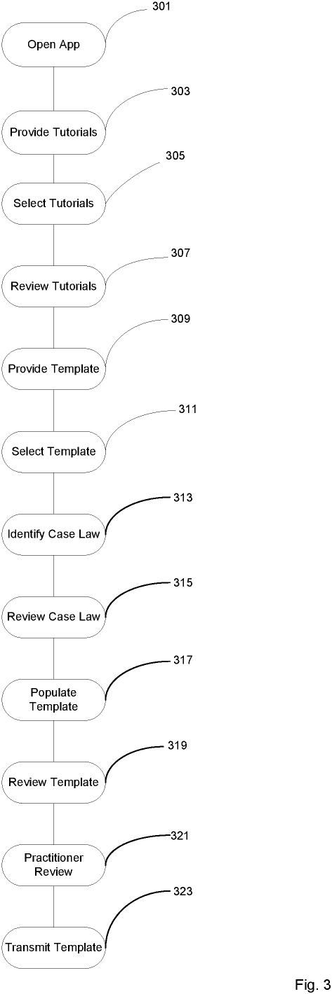

Now referring to FIG. 3 herein, the legal examination and practice method 100 includes an alternate exemplary workflow method as diagrammed therein. In step 301, the user will open the software application of the present invention on their computing device 20. In step 303, the legal examination and practice method 100 provides a catalog of legal tutorials for the user to choose from. It should be understood within the scope of the present invention that the legal tutorials could be in all types of law and include topics such as but not limited to court filing procedures and legal document overviews. Step 305, the user will select a tutorial from the provided catalog. In step 307, the user will review the tutorial. It should be understood within the scope of the present invention that the tutorial could include video as well as exemplary documents and filing simulations.

In step 309, the software application provides a catalog of legal templates to the user. The catalog of legal templates provided by the legal examination and practice method 100 can include but is not limited to, civil court filing templates and criminal court filing templates. Step 311, the user will select a legal template needed for their current legal proceeding. In step 313, based on the legal template selected, the software application will automatically identify and provide any current relevant case law to the user for review prior to completing the template. Step 315, the user will review the case law wherein the review will be assisted by the software application wherein the software application will highlight important rulings and/or language therein. In step 317, the user will populate the selected legal template. During this step, the artificial intelligence engine is utilized to determine correct population of the template to ensure compliance with either civil or criminal procedural law requirements. Step 319, ensuing completion of the legal template, the user will review the legal template to ensure all required information has been inputted into the legal template. In step 321, the software application will prompt a user to inquire if they desire to be connected to a legal practitioner that specializes in the area of law of the legal template. If desired, the software application facilitates direct communication with a legal practitioner for assistance and/or review of the legal template. Step 323, ensuing satisfactory completion and review of the legal template the software application of the present invention can facilitate the filing of the legal template with the appropriate authorities via the court access portal 10.

While examples of the legal examination and practice method 100 and its software application have been provided herein, it should be understood within the scope of the present invention that the legal examination and practice method 100 could include additional legal assistance. It should be further understood that the present invention is executed in all languages, includes access to all types of legal practitioners and further includes training for user that desire to engage in pro-se representation. Additionally, the software application will facilitate remote electronic notarization of any document for a user.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for executing review of a legal document wherein the method comprises the steps of:
publishing a software application, wherein the software application is published to a computing device wherein the computing device is accessible via conventional communication protocols;
downloading the software application, wherein users download the software application to a remote computing device;
creating a profile with the software application, wherein the users will create a profile with the software application containing personal identification information;
inputting a preferred parameter list, wherein the user inputs at least one preferred parameter, wherein the preferred parameters established a legal or moral boundary of the user;
receiving a legal document, wherein the software application will receive at least one legal document for which the user needs review thereof;
reviewing the legal document, wherein the software application of the present invention provides a review of the legal document;
cross referencing the legal document with the at least one preferred parameter, wherein the software application reviews language within the legal document to ensure compliance with the at least one preferred parameter;
providing notification to the user of compliance with the at least one preferred parameter, wherein the software application provides notification of compliance or noncompliance with the at least one preferred parameter;
offering translation of at least one legal term, wherein the software application provides further definition of at least one legal term present in the legal document; and
facilitating execution of the legal document, wherein the software application facilitates the user execution of the legal document ensuing review thereof.

2. The method for executing review of a legal document as recited in claim 1, and further including a step of providing a template, wherein the template is provided to the user to facilitation completion of a legal document or filing of a legal proceeding.

3. The method for executing review of a legal document as recited in claim 2, and further including providing a step of identifying case law, wherein the software application of the present invention provides identification of case law relevant to a user’s legal need.

4. The method for executing review of a legal document as recited in claim 3, and further including a step of providing a plurality of tutorials, wherein the plurality of tutorials facilitate an ability for the user to engage in pro-se practice of all types of law.

5. The method for executing review of a legal document as recited in claim 4, and further including a step of highlighting a mismatch between the at least one preferred parameter and language in the legal document, wherein the software application of the present invention identifies the mismatch providing a list thereof.

6. The method for executing review of a legal document as recited in claim 5, and further including a step of facilitating communication with a legal practitioner, wherein the legal practitioner could be from any discipline of legal practice.

7. The method for executing review of a legal document as recited in claim 6, and further including a step of validating fact statements embedded within the legal document, wherein the software application provides detection of fact statements in the legal document and provides validation with at least one external resource.

8. The method for executing review of a legal document as recited in claim 7, and further including a step of populating a legal template, wherein the software application facilitates automated population of a legal template wherein the legal template is utilized for filing in a legal proceeding.

9. The method for executing review of a legal document as recited in claim 8, and further including a step of transmitting the legal document to a legal practitioner, wherein the software application of the present invention provides transmission of the legal document to a legal practitioner for review thereof.

10. The method for executing review of a legal document as recited in claim 9, and further including a step of enabling a reduced fee, wherein the software application provides review of the legal document in order to reduce a billing amount from a legal practitioner.
